(19) United States
(12) Patent Application Publication
(10) Pub. No.: US 2013/0133233 A1
(43) Pub. Date: May 30, 2013

(54) ADVERTISING DISPLAY DEVICE POSITIONED ABOVE GROUND FOR FOOTBALL PLAYING FIELDS

(71) Applicant: Trade, Kiss and Business, S.L., Sevilla (ES)

(72) Inventor: Rodriguez Perez, Sevilla (ES)

(73) Assignee: Trade, Kiss and Business, S.L., Sevilla (ES)

(21) Appl. No.: 13/687,210

(22) Filed: Nov. 28, 2012

(30) Foreign Application Priority Data
Nov. 30, 2011 (ES) 201131241 U

(51) Int. Cl. G09F 17/00

(52) U.S. Cl. CPC G09F 17/00
USPC 40/603

(57) ABSTRACT

An advertising display device positioned above ground for football playing fields comprising:
a material (1) capable of printing on both sides.
at least one connecting system provided with a tensioning cord for tightening the material (1) to the goal construction having an external frame connected to the playing field and another external frame attached to the net of the goal.

### FIELD OF THE INVENTION

The present invention relates to advertising devices, especially to those positioned above ground in football playing fields.

### BACKGROUND OF THE INVENTION

Nowadays there exist different types of displays within the playing field at football stadiums, which include perimeter displays with led fence lighting, and lateral displays on the field and football goals. Sometimes those displays may annoy or inconvenience the football players and affect the adequate development of the match in a way that participants may trip or fall. Moreover reaction times can be influenced because of space limitation.

It is common to place advertising displays around football goals by means of screen printed meshes, digital fence lighting, which limit and enclose the field of play, and 3D screen printed panels showing different fonts and logos. However, these displays are in direct, close contact with the players and participants and usually reduce the space available for sprint and run.

### DESCRIPTION OF THE INVENTION

The present invention provides an advertising device positioned above ground in football playing fields, comprising:
a material capable of printing on both sides,
at least one connecting system provided with a tensioning cord for tightening the material to the goal construction, having an external frame connected to the playing field and another external frame attached to the net of the goal, from which the material capable of printing on both sides hangs at a suitable height.

The material can be made of mesh, canvas and other fabrics, comprising:
a first fold in the upper end of the material, wherein said fold is configured to accept the connection of the mesh by a tensioning cord incorporated to the net of the goal.
a second fold in the lower end of the material, wherein said fold is configured to accept a counterbalance mechanism to withstand adverse weather conditions like high winds.

The material used to fabricate the mesh, canvas, fabric or any other material capable of printing, shall be of such nature or form that signs, logos and/or advertising designs can be printed thereon.

Brackets, grommets or any other known means can be used to fix and hang the mesh using the tensioning cord.

The tension applied to the cord attached to the net of the goal will not affect nor counterbalance the cord or the net, given the light weight of the mesh itself.

This new advertising display system is intended to provide a greater advertising impact, having a display area that correlates directly with TV shots. Moreover, no other advertising display devices will intervene in the game or involve the players or even cause risks, since it is positioned at a certain height and sidewalls, in accordance with the respective FIFA competition regulations.

Another object of the present invention is that the new device protects football players from injury when running into goal posts, the goal area or outside the field of play, since it is positioned above ground level and it does not reduce the available space for the players and their safety. It also allows for safe deceleration or slide, as there are no obstacles

### BRIEF DESCRIPTION OF THE DRAWINGS

The following specific drawings provided herein are useful for illustrating the nature of the present invention. These drawings are included solely for illustrative purposes and must not be interpreted as limitations to the invention claimed herein.

FIG. 1 is a schematic representation of the invention.

The above mentioned figure includes a series of references with the sole purpose of facilitating the comprehension of the characteristics of the invention, with an illustrative and non limiting character:

1. mesh

2. upper fold of the mesh

3. lower fold of the mesh

4. tensioning cord

5. football goal

6. net of the goal

### DETAILED DESCRIPTION

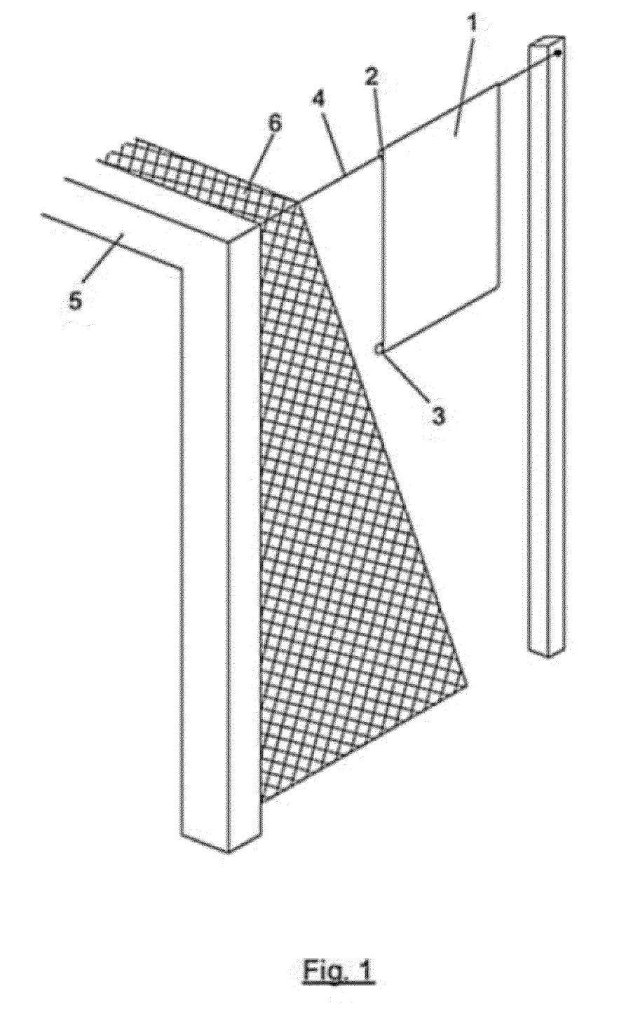

As shown in the FIG. 1, the advertising display device positioned above ground for football playing fields comprises one mesh (1) comprising:
a first fold (2) in the upper end of the material, wherein said fold is configured to accept the connection of the mesh (1) by a tensioning cord (4) incorporated to the net (6) of the goal (5) and fixed by stitchers, brackets, grommets or any other known means, and
a second fold (3) in the lower end of the material, wherein said fold is configured to accept a counterbalance mechanism to withstand adverse weather conditions like high winds.

1. An advertising display device positioned above ground for football playing fields comprising:
a material (1) capable of printing on both sides.
at least one connecting system provided with a tensioning cord for tightening the material (1) to the goal construction having an external frame connected to the playing field and another external frame attached to the net of the goal, from which the material capable of printing on both sides hangs at a suitable height.

2. An advertising display device positioned above ground according to claim 1 wherein said material (1) is capable of printing and has a first fold (2) in the upper end of the material, and said configuration has a tensioning cord (2) incorporated to the net (6) of the goal (5)

3. An advertising display device positioned above ground according to claim 2 wherein said fold (2) is fixed to the said material (1) by means of brackets, stitchers or grommets.

4. An advertising display device positioned above ground according to claim 1-3 wherein said material (1) capable of printing comprises a second fold (3) in the lower end of the material configured to accept a counterbalance mechanism.

5. An advertising display device positioned above ground according to the previous claims characterized by the fact that said material (1) capable of printing can be made of mesh, canvas and other fabrics.
